(19) United States
(12) Patent Application Publication
(10) Pub. No.: US 2001/0013860 A1
(43) Pub. Date: Aug. 16, 2001

(54) Keyboard matrix expansion

(76) Inventor: Edward Peter Gancarcik, Ottawa (CA)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 09/782,410

(22) Filed: Feb. 12, 2001

(30) Foreign Application Priority Data
Feb. 10, 2000 (GB) 0003975.9.3

(51) Int. Cl. G09G 5/00

(52) U.S. Cl. 345/168

(57) ABSTRACT

A keyboard matrix circuit includes means defining a first junction location and a second junction location. Two switches are wired in parallel between the junction locations, each switch being in series with a diode, and the two diodes being oppositely directed. Each junction location connects to line voltage along a current path which includes a resistance, so that current flow from line voltage to the respective junction location will cause that junction location to have a voltage lower than line voltage. For each junction location there is defined a current path permitting current to flow away from the respective junction location. Also, for each junction location current path there is provided a control means which either allows or disallows current flow along the respective location current path. Monitoring means, preferably in the form of gates, are provided for detecting the voltage level at the respective junction location, thus providing a reading from which can be determined the open/closed status of the respective switch.

### BACKGROUND OF THIS INVENTION

The conventional circuit which is currently utilized in a keyboard matrix involves two junction locations between which is connected a simple on-off switch (for example, provided as one of the keys of a keyboard). Between one of the junction locations and line voltage there is provided a current path which includes a resistance. The other junction location can be switched between a condition in which it can receive current, and a condition in which it will not receive current. When switched to receive current, the closing of the switch will complete a current path from line voltage to the first junction location and through the switch, thus allowing current to pass through the resistance, thus lowering the voltage of the junction location connected through the resistance to the line voltage. Typically, appropriate input/output gates are provided, and these are arranged so as to monitor the voltage at the junction location which directly connects (through the resistance) to the line voltage.

Appropriate software controls the input/output modality.

### GENERAL DESCRIPTION OF THIS INVENTION

The present invention provides an enhanced circuit which effectively doubles the number of keys in a keyboard matrix while adding only minimal additional components. This is significant because it reduces the number of pins required in an application specific circuit (ASIC).

More particularly, this invention provides, in a keyboard matrix circuit in which a first switch is adapted to make or break a connection between a first junction location and a second junction location, said circuit including a first current path from line voltage to the first junction location, said first current path including a resistance such that, if current flows along said first current path from line voltage to said first junction location, the voltage at the first junction location drops, first monitoring means connected so as to monitor the voltage at the first junction location, said circuit further including a second current path connected to the second junction location and controllable to either allow or disallow the flow of current along said second current path, whereby when current flow along said second current path is allowed, the closing of said first switch permits current flow along both current paths and through the first switch, thus lowering the voltage at the first junction location,

the improvement comprising:

a) the provision of a second switch wired in parallel with said first switch between said two junction locations, each switch being connected in series with a diode, the two diodes being oppositely directed so that one diode allows current flow only toward the first junction location, and the other diode allows current flow only toward the second junction location,

b) the provision of a third current path from line voltage to said second junction location, said third current path including a resistance such that, if current flows along said third current path from line voltage to said second junction location, the voltage at the second junction location drops,

c) the provision of a fourth current path connected to the first junction location and controllable to either allow or disallow the flow of current along said fourth current path, whereby when current flow along the fourth current path is allowed, the closing of the second switch permits current flow along the third and fourth current paths and through the second switch, thus lowering the voltage at the second junction location, and

second monitoring means connected so as to monitor the voltage at the second junction location.

Further, this invention provides a keyboard matrix circuit comprising:

a first junction location and a second junction location,

a first switch adapted to make or break a connection between said locations,

a first current path from line voltage to the first junction location, said first current path including a resistance such that, if current flows along said first current path from line voltage to said first junction location, the voltage at the first junction location drops,

first monitoring means connected so as to monitor the voltage at the first junction location,

a second current path connected to the second junction location and controllable to either allow or disallow the flow of current along said second current path, whereby when current flow along said second current path is allowed, the closing of said first switch permits current flow along both current paths and through the first switch, thus lowering the voltage at the first junction location,

a second switch wired in parallel with said first switch between said two junction locations,

each switch being connected in series with a diode, the two diodes being oppositely directed so that one diode allows current flow only toward the first junction location, and the other diode allows current flow only toward the second junction location,

a third current path from line voltage to said second junction location, said third current path including a resistance such that, if current flows along said third current path from line voltage to said second junction location, the voltage at the second junction location drops,

a fourth current path connected to the first junction location and controllable to either allow or disallow the flow of current along said fourth current path, whereby when current flow along the fourth current path is allowed, the closing of the second switch permits current flow along the third and fourth current paths and through the second switch, thus lowering the voltage at the second junction location, and

second monitoring means connected so as to monitor the voltage at the second junction location.

Finally, this provides a keyboard matrix circuit comprising:

means defining a first junction location and a second junction location,

two switches wired in parallel between the junction locations, each switch being in series with a diode, the two diodes being oppositely directed,

each junction location being connected to line voltage along a junction current path which includes a resistance, whereby current flow from line voltage to the respective junction location along the respective junction current path will result in the respective junction location having a voltage below line voltage,

for each junction location, means defining a location current path permitting current to flow away from the respective junction location,

for each location current path a control means which either allows or disallows current flow along the respective location current path, and

for each junction location, monitoring means for detecting the voltage level at the respective junction location, thus providing a reading from which can be determined the open/closed status of the respective switch.

### GENERAL DESCRIPTION OF THE DRAWINGS

One embodiment of this invention is illustrated in the accompanying drawings, in which like numerals denote like parts throughout the several views, and in which:

FIG. 1 shows a circuit unit, used in current keyboards, in which the switch symbol represents the key contact when the key is depressed;

FIG. 2 shows a 3×3 matrix which includes nine of the units illustrated in FIG. 1 (much simplified in FIG. 2);

FIG. 3 is a circuit diagram similar to FIG. 1, but showing the additional components which effectively double the total number of keys available; and

FIG. 4 is a view similar to FIG. 2, showing the wiring of the 3×6 keyboard obtained when applying this invention to the FIG. 2 arrangement.

### DETAILED DESCRIPTION OF THE DRAWINGS

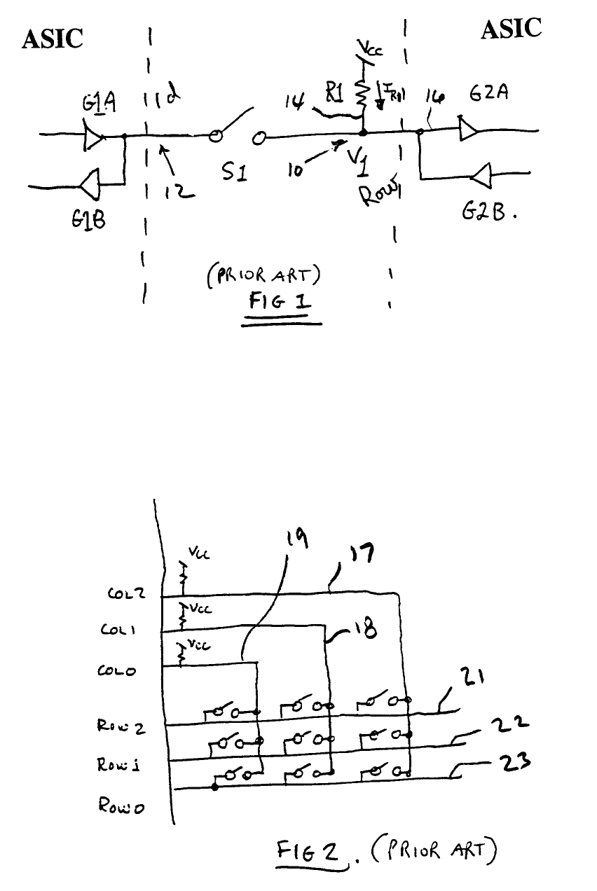

Attention is directed first to FIG. 1, which shows a switch S1 in a line connecting a first junction location 10 with a second junction location 12. When used in this disclosure and in the appended claims, the expression “junction location” is merely intended to designate a portion of the circuit which forms an integral unit without resistances or switches between the various portions. There is not necessarily an actual “junction” present. Thus, in FIG. 1, the switch S1 clearly exists between and connects together the two “junction” locations marked by the numerals 10 and 12. It will be clear from the figure that the switch S1 is adapted to make or break a connection between these locations. Extending from the first junction location 10 (upwardly in FIG. 1) is a current path 14, the upper end of which is connected to line voltage (power supply voltage). The first current path 14 contains a resistance R1 such that, if current flows along the current path 14 from line voltage to the first junction location 10, the voltage at the first junction location will drop (due to the IR loss).

Monitoring means in the form of a gate G2A is connected by way of the line 16 so as to monitor the voltage at the first junction location 10.

The circuit further includes a second current path which includes a gate G1A connected to the second junction location 12. By switching the G1A gate to logic low, the current flowing through the resistance R1 will be able to escape from the junction location 12. This will cause VI to drop, and the software will recognize the lowered voltage at the junction location 10 as indicating that the appropriate key has been depressed. Specifically, the software would monitor the voltage at the G2A input.

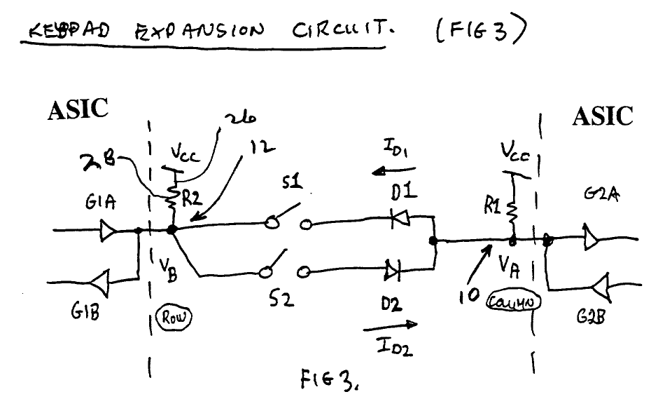

Attention is now directed to FIG. 2, also illustrating the prior art. In FIG. 2, there are three column lines 17, 18 and 19, and three row lines 21, 22 and 23. It will be seen that each column is connected to the three rows by way of three switches, making the illustrated arrangement a 3×3 matrix (i.e., nine keys in total).

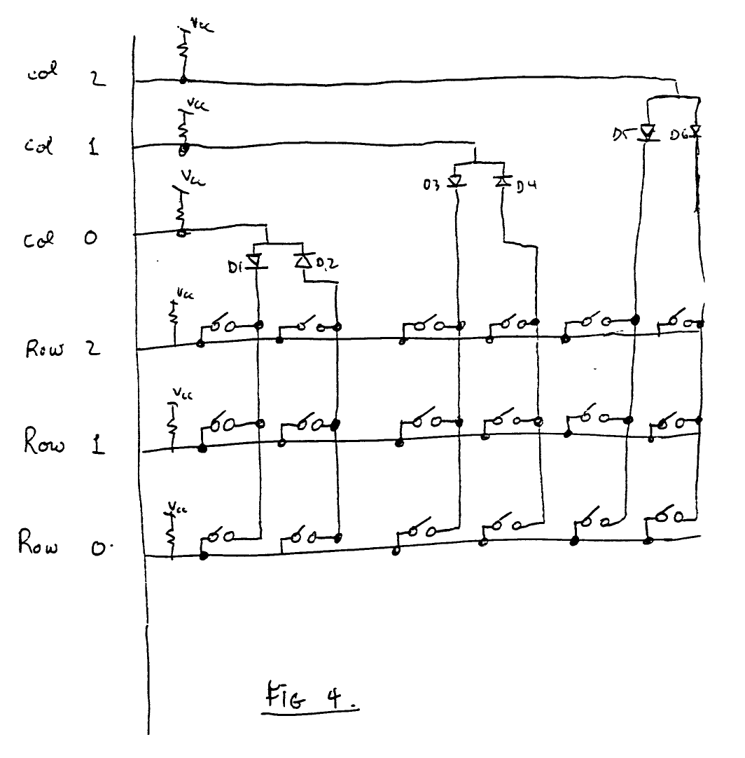

Attention is now directed to FIG. 3, which shows in detail the components added to the circuit of FIG. 1, in order to allow it to accommodate two switches (two keys in the keyboard).

As can be seen in FIG. 3, a second switch S2 is wired in parallel with the first switch S1 between the first junction location 10 and the second junction location 12. Further, switches S1, S2 are connected in series with diodes D1 and D2 respectively, the two diodes being in opposite directions, so that diode D2 allows current flow only toward the first junction location 10, and the other diode D1 allows current flow only toward the second junction location 12.

Also added is a further current path 26 connecting the second junction location 12 to line voltage, the current path 26 including a resistance 28 such that, if current flows along the further current path 26 from line voltage to the second junction location 12, the voltage at the second junction location 12 will drop.

It will now be appreciated that, when the gate G2B is grounded, the closing of the second switch S2 will allow current to flow from the line voltage, along the current path 26 and through the resistance 28, through the switch S2 and the corresponding diode D2, and finally to the gate G2B. With the gate G2B thus switched, monitoring takes place at the gate G1B.

As will now be clear, the circuit disclosed herein makes use of the fact that the bidirectional I/O's can be reversed (outputs become inputs and vice versa). The provision of the blocking diodes D1 and D2 allows an extra switch S2 to be detected.

The following is an overview of the basic operation of the unit circuit shown in FIG. 3.

For the detection of S1, G1A turns to logic zero. Current I_{D1} flows when S1 is closed, resulting in the VA voltage (the junction location 10) going low. If S2 were to be closed at the same time, there would be no effect on the operation of S1, due to the fact that diode D2 is reverse biased.

In order to detect S2, the circuit flips so that gate G2B is grounded and gate GIB is monitored. Closing S2 would result in I_{D2} flowing and voltage VB changing to approximately the logic zero level. Closing S1 will not affect the circuit because the diode D1 is reverse biased.

By comparing FIG. 4 with FIG. 2, it will be clear that the number of available switches (keys) is doubled by the utilization of the present invention.

More specifically, if the prior art arrangement of FIG. 2 were implemented in an application specific integrated circuit (ASIC), a total of six pins would be required for a 3×3 matrix (i.e., with nine switch positions). FIG. 4 shows how eighteen switch positions can be detected using the same six pins. In order to detect eighteen switches with the prior art implementation, a total of nine pins would be needed. As is well known, extra pins on an ASIC can be very costly in terms of die size and larger-than-needed packaging.

While one embodiment of this invention has been illustrated in the accompanying drawings and described hereinabove, it will be evident to those skilled in the art that changes and modifications may be made thereto without departing from the essence of the invention, as set forth in the appended claims.

The embodiments of the invention in which an exclusive property or privilege is claimed are defined as follows:

1. In a keyboard matrix circuit in which a first switch is adapted to make or break a connection between a first junction location and a second junction location, said circuit including a first current path from line voltage to the first junction location, said first current path including a resistance such that, if current flows along said first current path from line voltage to said first junction location, the voltage at the first junction location drops, first monitoring means connected so as to monitor the voltage at the first junction location, said circuit further including a second current path connected to the second junction location and controllable to either allow or disallow the flow of current along said second current path, whereby when current flow along said second current path is allowed, the closing of said first switch permits current flow along both current paths and through the first switch, thus lowering the voltage at the first junction location,
the improvement comprising:
a) the provision of a second switch wired in parallel with said first switch between said two junction locations, each switch being connected in series with a diode, the two diodes being oppositely directed so that one diode allows current flow only toward the first junction location, and the other diode allows current flow only toward the second junction location,
b) the provision of a third current path from line voltage to said second junction location, said third current path including a resistance such that, if current flows along said third current path from line voltage to said second junction location, the voltage at the second junction location drops,
c) the provision of a fourth current path connected to the first junction location and controllable to either allow or disallow the flow of current along said fourth current path, whereby when current flow along the fourth current path is allowed, the closing of the second switch permits current flow along the third and fourth current paths and through the second switch, thus lowering the voltage at the second junction location, and
d) second monitoring means connected so as to monitor the voltage at the second junction location.

2. The improvement claimed in claim 1, in which each of the first and second monitoring means includes a gate.

3. A keyboard matrix circuit comprising:
a first junction location and a second junction location,
a first switch adapted to make or break a connection between said locations,
a first current path from line voltage to the first junction location, said first current path including a resistance such that, if current flows along said first current path from line voltage to said first junction location, the voltage at the first junction location drops,
first monitoring means connected so as to monitor the voltage at the first junction location,
a second current path connected to the second junction location and controllable to either allow or disallow the flow of current along said second current path, whereby when current flow along said second current path is allowed, the closing of said first switch permits current flow along both current paths and through the first switch, thus lowering the voltage at the first junction location,
a second switch wired in parallel with said first switch between said two junction locations,
each switch being connected in series with a diode, the two diodes being oppositely directed so that one diode allows current flow only toward the first junction location, and the other diode allows current flow only toward the second junction location,
a third current path from line voltage to said second junction location, said third current path including a resistance such that, if current flows along said third current path from line voltage to said second junction location, the voltage at the second junction location drops,
a fourth current path connected to the first junction location and controllable to either allow or disallow the flow of current along said fourth current path, whereby when current flow along the fourth current path is allowed, the closing of the second switch permits current flow along the third and fourth current paths and through the second switch, thus lowering the voltage at the second junction location, and
second monitoring means connected so as to monitor the voltage at the second junction location.

4. A keyboard matrix circuit comprising:
means defining a first junction location and a second junction location,
two switches wired in parallel between the junction locations, each switch being in series with a diode, the two diodes being oppositely directed,
each junction location being connected to line voltage along a junction current path which includes a resistance, whereby current flow from line voltage to the respective junction location along the respective junction current path will result in the respective junction location having a voltage below line voltage,
for each junction location, means defining a location current path permitting current to flow away from the respective junction location,
for each location current path a control means which either allows or disallows current flow along the respective location current path, and
for each junction location, monitoring means for detecting the voltage level at the respective junction location, thus providing a reading from which can be determined the open/closed status of the respective switch.

5. A key matrix comprising a plurality of circuits as claimed in claim 3.

6. A key matrix comprising a plurality of circuits as claimed in claim 4.
